(19) United States
(12) Patent Application Publication
(10) Pub. No.: US 2026/0316479 A1
(43) Pub. Date: Oct. 15, 2026

(54) Book With Individually Illuminated, Design-Integrated Pages for Reading in Low Light

(71) Applicant: Lauren Alexovich, Redondo Beach, CA (US)

(72) Inventor: Lauren Alexovich, Redondo Beach, CA (US)

(21) Appl. No.: 19/647,719

(22) Filed: Apr. 14, 2026

Related U.S. Application Data
(60) Provisional application No. 63/789,227, filed on Apr. 15, 2025.

(51) Int. Cl. B42D 1/00; F21K 9/61; F21V 8/00; F21V 33/00; F21W 131/30

(52) U.S. Cl. CPC B42D 1/003; F21K 9/61; F21V 33/0048; G02B 6/0051; F21V 2200/20; F21W 2131/3005

(57) ABSTRACT

A book having a plurality of selectively illuminable pages is provided. Each page has an outward-facing printed layer and an illuminating layer positioned behind the printed layer configured to backlight text and/or illustrations on the outward-facing printed layer. The illuminating layer may comprise an electroluminescent panel, light guide plate, or light-emitting diodes. One or more modifying layers may be disposed between the printed layer and illuminating layer to selectively transmit, block, or filter light, thereby altering the visual appearance of the printed content and improve visibility in low light conditions. The modifying layers may be configured to produce visual effects including highlighting, shadowing, revealing hidden imagery, modifying colors, and/or combinations of the same when illuminated. Electrical circuitry and a power source are operatively connected to the illuminating layers and may include user-actuatable controls for selectively activating illumination of individual pages or groups of pages.

### CROSS-REFERENCE TO RELATED APPLICATIONS

Pursuant to 35 U.S.C. § 119(e), this application claims the benefit of United States Provisional Patent Application No. 63/789,227 filed on Apr. 15, 2025, the entire contents of which are hereby incorporated by reference.

### GOVERNMENT CONTRACT

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to a book, and more particularly to a book having individually configured illuminating pages for viewing in the dark.

### BACKGROUND

Reading to children at bedtime is a common and cherished routine in many households. It fosters early literacy, strengthens caregiver-child bonds, and helps children wind down for sleep. However, one persistent challenge is the difficulty of reading children's books in low-light or dark environments, such as a bedroom at night.

Many prefer to keep lighting dim during bedtime reading to avoid overstimulating the child or disrupting their natural sleep cycle. Unfortunately, most printed books, including children's books, require a direct light source to be readable. This often results in the use of external lamps or flashlights, which can be cumbersome to handle while also holding a child or turning pages. Additionally, such light sources may cast uneven lighting or create shadows that interfere with clear reading.

Similar difficulties arise in outdoor or low-light settings, such as at campgrounds, where reading a children's book could be a fun and memorable bonding opportunity, but where lighting conditions often make it impractical or frustrating.

While these problems exist for books generally, they are compounded in the case of children's books, which often rely heavily on visual storytelling through colorful illustrations. Poor lighting not only makes text difficult to read, but also diminishes the visual impact of the artwork and reduces the overall experience for the child and reader.

Some have proposed solutions such as low-profile, clip-on book lights or bedside lamps, however, these often fail to provide adequately uniform illumination and may distract children while in use. Likewise, some have proposed exposing individual light bulbs or light emitting diodes supported in a portion of a book through aligned openings defined by superimposed pages. However, these typically fail to provide sufficient surface illumination, limiting low-light readability and aesthetic effect on illustrations. Additionally, such configurations can result in harsh, point-source lighting lacking diffusion, resulting in bright spots and shadows that can be distracting or visually unpleasant.

Other proposals for integrating lights into the structure of a book include, for example, U.S. Pat. No. 4,209,824 to Kaufman, which features individual, multi-colored lamps on each page; U.S. Pat. No. 5,301,982 to Brotz, which teaches self-illuminated polymer film imprinted with opaque or translucent indicia; U.S. Pat. No. 8,087,794 to Stravinskas et al. teaches a book in which light emitting diodes are embedded in a regular array within translucent sheets to diffuse their emitted light through a book page; and U.S. Pat. No. 10,137,720 to Hudacheck teaches an illuminated book having pages comprising transparent or translucent material permitting transmission of light from an underlying light diffusing panel. However, these all suffer from various deficiencies, including bulky or impractical designs, uneven or harsh lighting, limited visual appeal, and lack of effective light diffusion across the entire page. These issues can result in poor readability, distracting glare, and reduced aesthetic or functional value, particularly in the context of children's books or low-light reading environments. And none of the existing patents can be integrated into a standard board book format.

Thus, although various proposals have been made to solve the problem(s), none of those in existence combine the characteristics of the present invention. Therefore, there remains a need for a book in a standard board book format that is both visually engaging and capable of being read in low light environments.

### SUMMARY

The present disclosure is directed to a book having pages containing lighting elements and layered sheets of material configured to visually enhance any wording and/or illustrations featured on each page, which may be individually backlit by the lighting elements to enable reading in low-light and dim environments.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

In accordance with one embodiment, each page of the book comprises a plurality of layers, including at least an outward-facing printed layer comprising visible text and/or illustrations, and an illuminating layer positioned behind the outward-facing printed layer.

In some embodiments, at least one additional modifying layer may be interposed between the outward-facing printed layer and the illuminating layer.

The illuminating layer serves not only to backlight and illuminate the text and/or illustrations on the outward-facing printed layer for readability in low-light environments, but can also be configured to alter the appearance of the illustrations. The penetration of light through the outward-facing printed layer from behind can be manipulated to introduce shadows, highlights, and color transformations, such as transitioning from a black and white to a colored image, thereby enhancing the reader's visual experience.

The outward-facing printed layer may be a solid sheet of material made from any type of paper or other material suitable for both printing and backlighting, including for example only and not limitation, various types and weights of paper, cardstock, paper stock, and paperboard, featuring either glossy or matte surface treatment, which may be known to those of ordinary skill in the art.

The one or more modifying layers interposed between the outward-facing layer and the illuminating layer may comprise any combination of opaque, light-blocking layers and/or transparent, semi-transparent, translucent, and/or light-filtering layers, and combinations of the same, such as color-printed paper, cardstock, film, or other suitable sheets of material.

Such modifying layers may be configured and arranged so that, when the illuminating layer is activated, the illuminating layer backlights the outward-facing printed layer in a manner that is influenced or altered by the presence and design of the modifying layer(s). For example, an opaque modifying layer such as black cardstock may be cut or shaped to block light penetration in all areas except designated cutout portions, creating a highlight effect on a featured portion of the printed layer.

Alternatively, a modifying layer may be configured as a border around a featured portion of an illustration and/or text and even around individual letters comprising text on the printed layer.

In some embodiments, illuminating layers of varied visual contrast may reveal features drawn or printed on a modifying layer that would otherwise be invisible to the reader through the outward-facing printed layer.

In still other embodiments, color may be added to the outward-facing printed layer when the illuminating layer is activated by interposing a light-permeable modifying layer having a colored image or color printing applied to its surface.

Light filtering film may also be interposed between the outward-facing printed layer and the illuminating layer, or applied to some other substrate as an additional modifying layer, to affect perceived color, brightness, or contrast of desired portions of the text and/or imagery when backlit. The number, type, and configuration of modifying layers may vary depending on the particular lighting effects desired for each individual page, and pages without any illuminating features may also be included without departing from the invention.

The illuminating layer may take any of several forms. In some exemplary and non-limiting embodiments, for example, the illuminating layer may be a side-lit light emitting diode (LED) light guide plate using a thin, flexible PVC or acrylic panel, onto which microdots known to those of ordinary skill in the art are printed, painted, or lasered in a matrix pattern to enable even distribution of light across the panel, thereby uniformly illuminating the book page.

In some embodiments, the illuminating layer may be an electroluminescent light panel (“EL panel”). It is contemplated that this may increase the type and configuration of lighting effects available.

In still other embodiments, the illuminating layer may also be LED ribbon lights arranged and secured to a light guide plate to effectuate an apparently solid but diffuse backlight for the outward-facing printed layer and any modifying layers.

Indeed, in still other embodiments, the illuminating layer may comprise flexible and even cuttable LED sheets.

It is contemplated that fairy lights and LED light arrays may also be used to practice the invention. In such cases, additional diffuser layer(s) may be employed to spread the light enough to obscure the individual lights through the printed outer layer or each page.

It is contemplated that means for electrically powering each illuminating layer may be housed within a portion of the book, such as within the back cover, front cover, or spine, and include an electric power source operatively connected to all illuminating layers comprising the pages of the book, along with a digitally actuated switch for selectively energizing such layers.

In some embodiments, the electric power source and digitally actuated switch may be mounted on the cover.

The illuminating layer or layers may be operated via electronic circuitry comprising, for example, flip flops, gates, and programmable processors, which are known to those of ordinary skill in the art. Such circuitry may be configured to illuminate all pages, a single page, or a pair of facing pages at a time, which may also serve to conserve power during operation.

Activation of each illuminating layer may be controlled by a reader through switches, known to those of ordinary skill in the art, accessible via each outward-facing printed layer or pair of outward-facing printed layers. This may permit selective illumination of one page or pair of pages at a time.

However, it is also contemplated that a switch, such as a latching button switch or even toggle switch, may be disposed on the front cover, back cover, or spine of the book. In some embodiments, such a switch may be operative to illuminate all pages simultaneously. In some embodiments, however, such a switch may be configured to enable selection of which individual page or pair of facing pages is illuminated at a time.

In some embodiments, the switches may be momentary buttons or membrane switches accessible from each outward facing printed layer. Indeed, in some embodiments, membrane switches may be provided due to their durability, low weight, lack of moving parts, and sealed, easy-to-clean surface. In such cases, each outward-facing printed layer may define printed indicia corresponding to the switch location or otherwise define a hole or other opening granting physical access to such switch. In this manner, a reader may selectively activate the illuminating layer corresponding to a particular page or pair of facing pages. It is to be understood, however, that any such opening is provided solely for switch access and not for the purpose of admitting light. That is, illumination of the outward-facing printed layer is achieved by backlighting through the material of the outward-facing printed layer itself, rather than through any cutout or interruption in the printed surface.

As such, it will be understood that alternative switches may also be used without departing from the invention, however, including where it is desirable to avoid cutouts or interruptions in the outward-facing printed layers.

Any circuitry to control the exemplary membrane switches may comprise flip-flop components operative to store and toggle binary states in response to user inputs, enabling selective activation of illuminating layers while deactivating others, supporting page-by-page or spread-by-spread illumination as desired.

In one contemplated embodiment, each illuminating layer, such as the exemplary EL panel or side-lit LED light guide plate, may be sized to correspond to the dimensions of the outward facing printed layer. However, it will be understood that the outward-facing printed layer may extend beyond the boundaries of the illuminating layer so as to fully conceal the illuminating layer and any associated circuitry from view.

In some exemplary embodiments then, the illuminating layer may be about 5 cm wide to about 25 cm wide and about 5 cm tall to about 25 cm tall. In some embodiments, the illuminating layer may define a panel of about 10 cm×10 cm configured to run off a conventional 3V power source, permitting use of conventional AA, AAA, or even coin cell batteries.

Larger panels may also be used, though one of ordinary skill in the art will appreciate that these may require proportionally more power due to increased energy demands.

The means for securely layering elements comprising each page may vary and shall not limit the invention. In some embodiments, some or all of the layers and other elements comprising the book may be provided unsecured to one another as part of a kit for assembly and/or personalization by the user, including means to create, decorate, and/or modify one or more outward-facing printed layers and/or modifying layers, and in some embodiments, electrical components for assembly as well.

Thus, it is an object of the invention to provide a book having pages with integrated illumination configured to backlight printed content.

It is another object of the invention to provide a layered page construction including one or more modifying layers configured to alter the visual appearance of text and/or illustrations when illuminated.

It is another object of the invention to provide a book capable of producing varied visual effects, including highlighting, shadowing, and color modification, through controlled illumination.

It is yet another object of the invention to provide a compact and durable illuminated book structure suitable for repeated handling and use.

It is still another object of the invention to provide an illumination system with user-actuatable controls configured to selectively activate illumination of individual pages or groups of pages.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 shows a front perspective view of a book in accordance with one embodiment of the invention.

FIG. 2 shows a rear perspective view of a book in accordance with one embodiment of the invention.

FIG. 3 shows exemplary embodiments of an outward-facing printed layer in accordance with one embodiment of the invention.

FIG. 4 shows an exemplary embodiment of a layered page in accordance with one embodiment of the invention.

FIG. 5A-C show exemplary embodiments of illuminating layers in accordance with certain embodiments of the invention.

FIGS. 6A-E show exemplary embodiments of modifying layers in combination with outward-facing printed layers in accordance with one embodiment of the invention.

The disclosed embodiments may be better understood by referring to the figures in the attached drawings, as provided below. The attached figures are provided as non-limiting examples for providing an enabling description of the claimed device. Attention is called to the fact, however, that the appended drawings illustrate only typical embodiments of this invention and are therefore not to be considered as limiting of its scope. One skilled in the art will understand that the invention may be practiced without some of the details included in order to provide a thorough enabling description of such embodiments. Well-known structures and functions have not been shown or described in detail to avoid unnecessarily obscuring the description of the embodiments.

Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

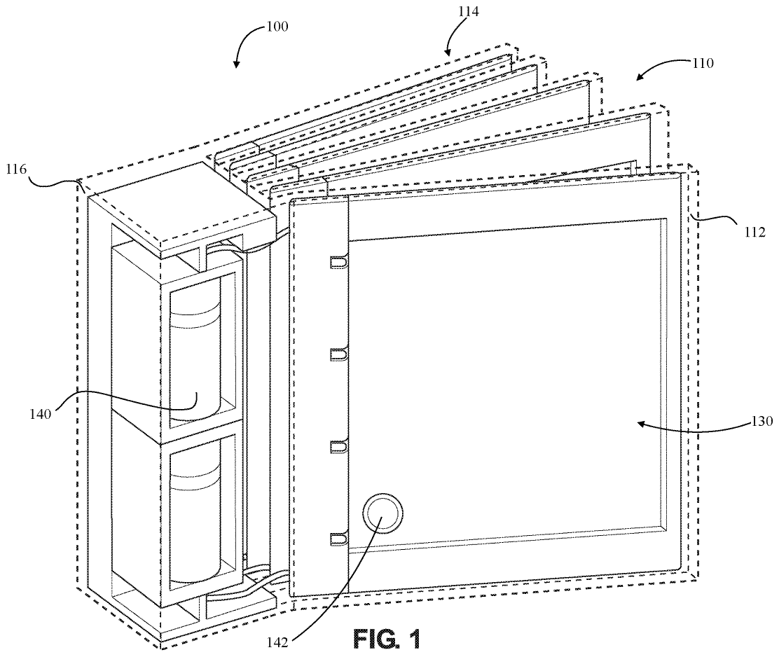

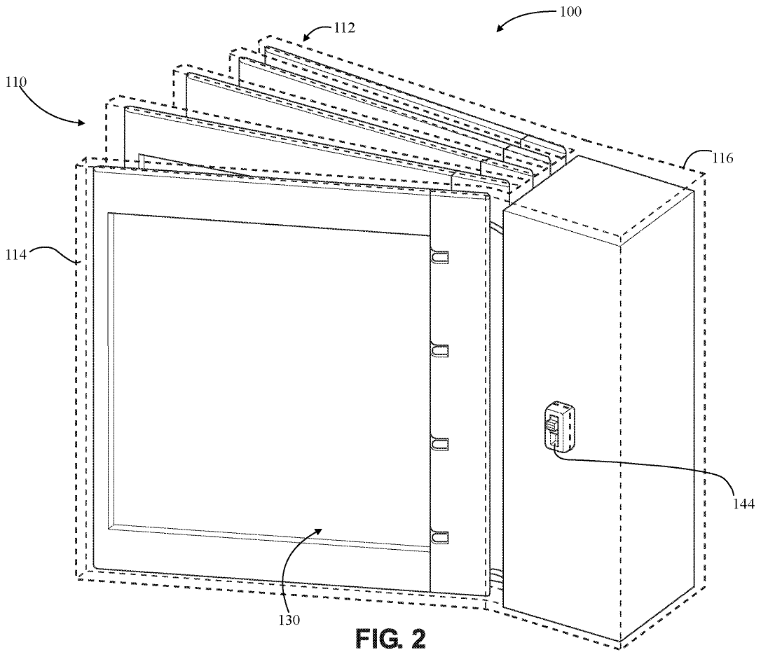

FIGS. 1 and 2 show a book 100 in accordance with one embodiment of the invention from a front perspective view and a rear perspective view, respectively. In some embodiments, the book 100 may comprise a plurality of pages 110 coupled to one another between a front cover 112 and back cover 114 along a spine 116. Various front covers, back covers, and spines are well known to those of ordinary skill in the art and will not limit the invention, and thus, the front cover 112, back cover 114, and spine 116 of FIGS. 1 and 2 are shown in phantom to reveal exemplary internal construction of the book 100.

Each page 110 further comprises a selectively illuminating layer 130 positioned within it and operative to backlight an outward-facing printed layer of the page 110 (discussed in greater detail below).

A power source 140, operatively coupled to each illuminating layer 130 and configured to selectively supply electrical power thereto, may be housed within the book 100. For instance, in exemplary FIG. 1, the power source 140 is housed within the spine 116, however, it is contemplated that the power source 140 may be housed in any of the front cover 112, back cover 114, or spine 116 of the book 100 as needed or desired. In some embodiments, the power source 140 may be configured to receive one or more conventional AA, AAA, or coin cell batteries known to those of ordinary skill in the art.

With continued reference to FIG. 1, a button switch 142, such as a momentary button switch, latching button switch, membrane switch, or capacitive touch switch operative to respond to the touch of a finger, may be disposed on or otherwise accessible via each page 110 and operatively coupled to the power source 140 to enable selective activation of the illuminating layer 130 of that page 110 or a pair of facing pages 110.

Turning to FIG. 2, a toggle switch 144 or the like may additionally or alternatively be disposed on the back cover 114 and operatively coupled to the power source 140, and may be configured to selectively control illumination of one or more of the illuminating layers 130 simultaneously.

Of course, the foregoing switches are provided for example only and not limitation. For instance, the particular shape, appearance, and/or placement of the switch(s) will not limit the invention. The foregoing are provided for the sake of clarifying examples only. One of ordinary skill in the art will recognize that a variety of switches may be operatively coupled to the power source to enable selective illumination of the book without departing from the invention.

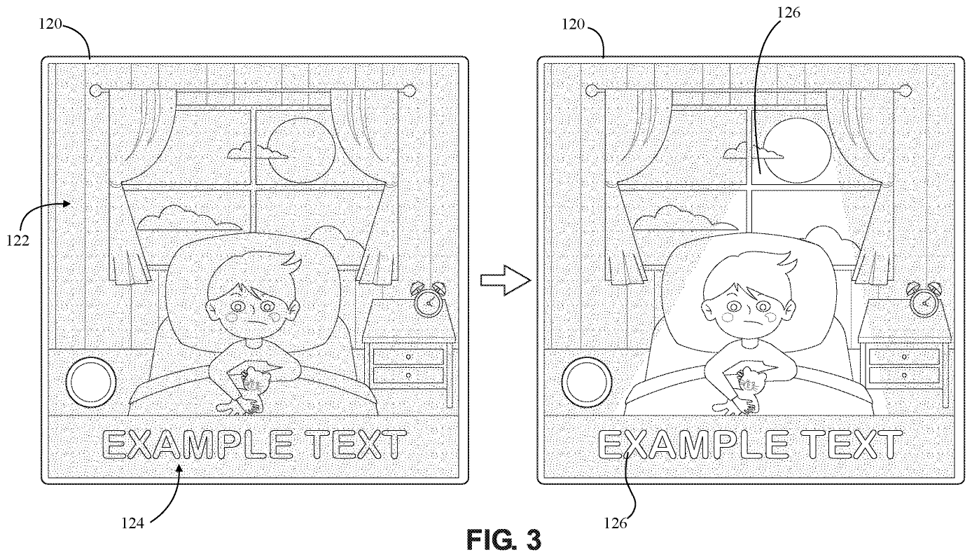

With reference to FIG. 3, exemplary embodiments of an outward-facing printed layer 120 in accordance with one embodiment of the invention are shown. The outward-facing printed layer 120 is the outermost layer of each page 110 and comprises text 122, illustrations 124, or a combination of the same, visible to a reader. The outward-facing printed layer 120 may be formed as a solid sheet of material selected from the group consisting of cardstock, paper stock, and paperboard, and may feature either a glossy or matte surface treatment.

The material comprising the outward-facing printed layer 120 may be selected to allow light 126a, 126b from the illuminating layer (obscured) to be perceptible therethrough. As such, many types and weights of paper, cardstock, paper stock, and even paperboard may be utilized for the outward-facing printed layer 120 without departing from the invention. Indeed, it is even contemplated that the outward-facing printed layer 120 may be formed, in part or in whole, from a polymeric sheet material, such as polypropylene, polyethylene terephthalate, or polycarbonate sheet, which may be particularly suitable for children's books intended for heavy use or exposure to moisture. Such materials may be compatible with standard printing processes and, like the paper-based materials described above, allow light from the illuminating layer to be perceptible therethrough, thereby enabling the backlighting effects described herein.

The outward-facing printed layer 120 may additionally define an opening 128 configured to permit a user physical access to the switch, such as exemplary button switch 142. However, is to be understood that any such opening 128 in the outward-facing printed layer 120 is provided solely for switch access and not for the purpose of admitting light. That is, illumination of the outward-facing printed layer 120 is achieved by backlighting through the material of the outward-facing printed layer 120 itself, rather than through any cutout or interruption in the printed surface.

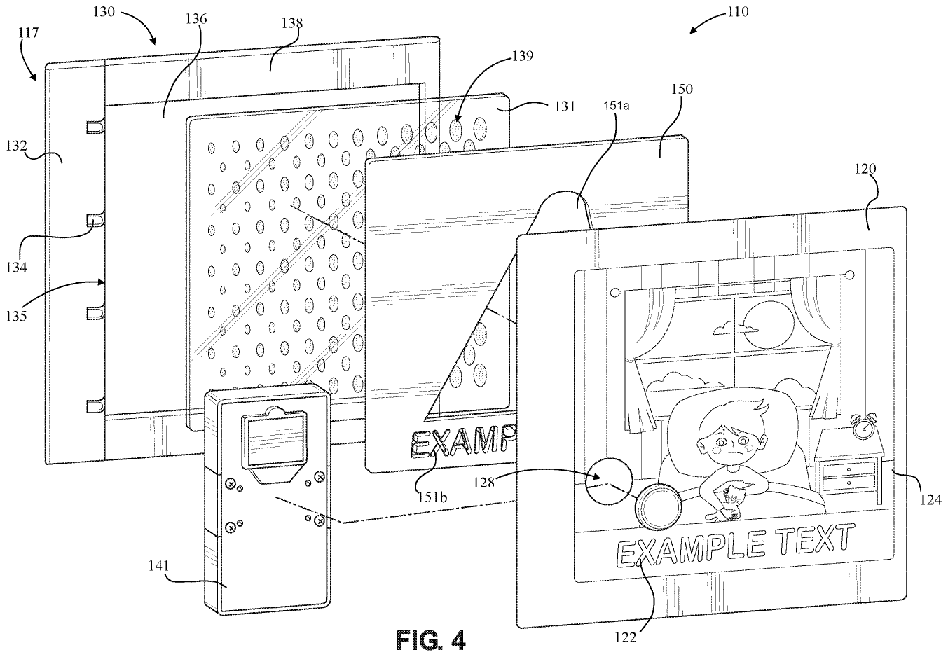

Notably, in FIG. 4, the power source is alternatively depicted as a self-contained electronics module comprising the power source and associated control circuitry in a compact housing 141 known to those of ordinary skill in the art. As such, the exemplary switch may be operative to control the illuminating layer 130 via electronic circuitry, known to those of ordinary skill in the art, housed, for example, with the power source.

For the purpose of providing a clarifying example, the circuitry operative to control the illuminating layer 130 of each page 110 may comprise conventional flip-flop components, known to those of ordinary skill in the art, operative to store and toggle binary states in response to user inputs. It is contemplated that this may enable selective activation of illuminating layers while deactivating others, thereby supporting page-by-page or spread-by-spread illumination as desired.

Activation of each illuminating layer 130 may be controlled by a reader through the exemplary switches, such as switch 142, accessible via each outward-facing printed layer 120 or pair of outward-facing printed layers 120, or alternatively through a switch disposed on the front cover, back cover, or spine of the book. It will be appreciated that in some embodiments, the aforementioned membrane switches may be provided due to their durability, low weight, lack of moving parts, and sealed, easy-to-clean surface, which may be particularly desirable for children's books.

FIG. 4 shows an exemplary embodiment of a layered page 110 in accordance with one embodiment of the invention. Each page 110 of the book 100 comprises a plurality of layers, including at least the outward-facing printed layer 120 and the illuminating layer 130 positioned behind the outward-facing printed layer 120. Moreover, one or more modifying layers 150 may be interposed between the outward-facing printed layer 120 and the illuminating layer 130. Such modifying layers 150 may comprise any combination of opaque, light-blocking layers and/or transparent, semi-transparent, translucent, and/or light-filtering layers, and combinations of the same, such as printed paper, cardstock, film, or other suitable sheets of material.

The modifying layer 150 may be configured and arranged so that, when the illuminating layer 130 is activated, such illuminating layer 130 backlights the outward-facing printed layer 120 in a manner that is influenced or altered by the presence, material characteristics, configuration, and even surface treatment of the modifying layer 150. Exemplary visual effects that may be achieved through such configuration include causing a highlight, shadow, color transformation, revealed hidden image, and any combination thereof to appear on the outward-facing printed layer 120.

That is, for the purpose of contextualizing following discussion of certain embodiments of the illuminating layer 130, it will be understood that the illuminating layer 130 may be configured not only to backlight and illuminate the text 122 and/or illustrations 124 on the outward-facing printed layer 120 for readability in low-light environments, but can also be configured to alter the appearance of the illustrations 124. That is, the penetration of light through the outward-facing printed layer 120 from behind can be manipulated to introduce shadows, highlights, and color transformations, such as transitioning from a black and white to a colored image, and even reveal hidden images, thereby enhancing the reader's visual experience.

For instance, the exemplary modifying layer 150 of FIG. 4 comprises an opaque sheet defining cutouts 151a, 151b corresponding to portions of text 122 and/or illustrations 124 on the outward-facing printed layer 120. The modifying layer 150 and some of its alternative embodiments will be discussed in further detail below.

With continued reference to the exemplary embodiment of FIG. 4, the illuminating layer 130 may comprise a side-lit LED light guide plate 132 in which a plurality of LEDs 134 are configured to direct light into an edge 135 of a thin flexible panel 136, such as a polyvinyl chloride (PVC) or acrylic panel, positioned along the spine side 117 of the page 110. A reflective foil frame 138 or other strip may be disposed along the perimeter of the panel 136 to direct light inward and prevent leakage at the edges.

In some embodiments, additional reflective or optically diffuse material may be provided to scatter and redirect the light outward toward the outward-facing printed layer 120. It is contemplated that this may enable even distribution of light across the panel 136, uniformly illuminating the page 110.

In some embodiments, the reflective or optically diffuse material may be microdots 139 printed, painted, or lasered onto the panel 136 or even onto an additional layer, such a thin film 131 or additional PVC or acrylic panel, in a matrix pattern. For example only and not limitation, such microdots may comprise reflective or optically diffuse materials such as white or titanium dioxide-based or other ink applied by printing or painting, a reflective coating or paint, or even surface deformations formed directly in the panel material by laser ablation, all of which are known to those of ordinary skill in the art.

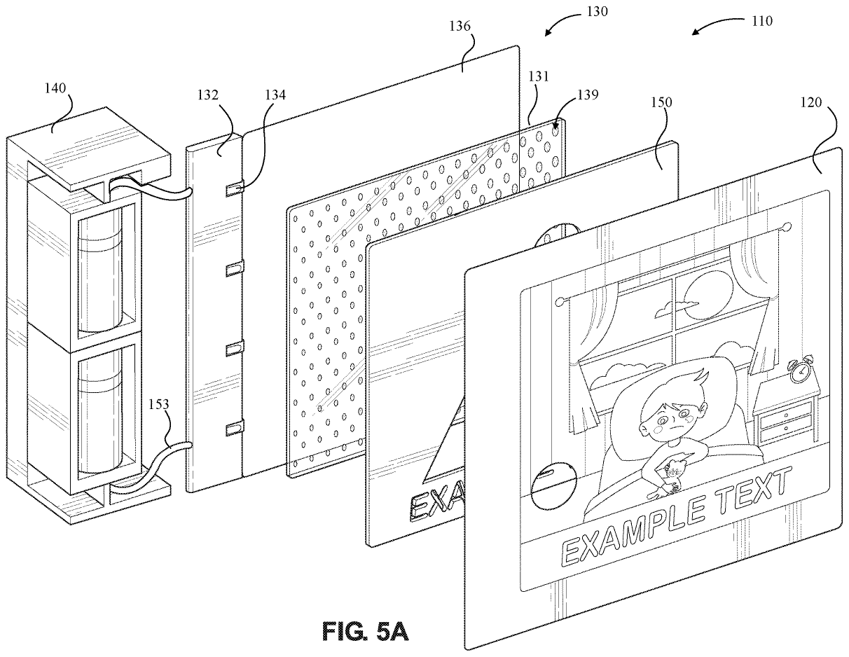

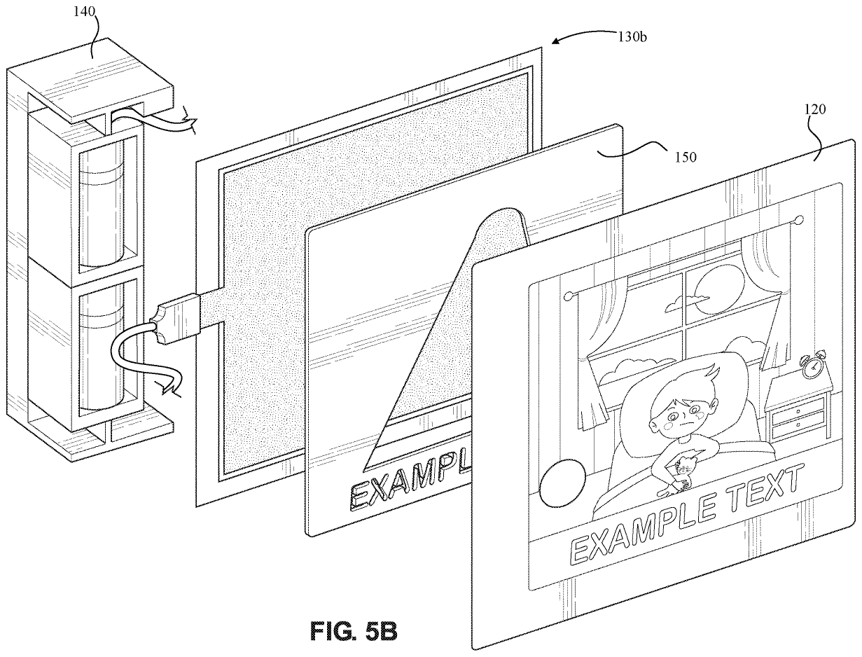

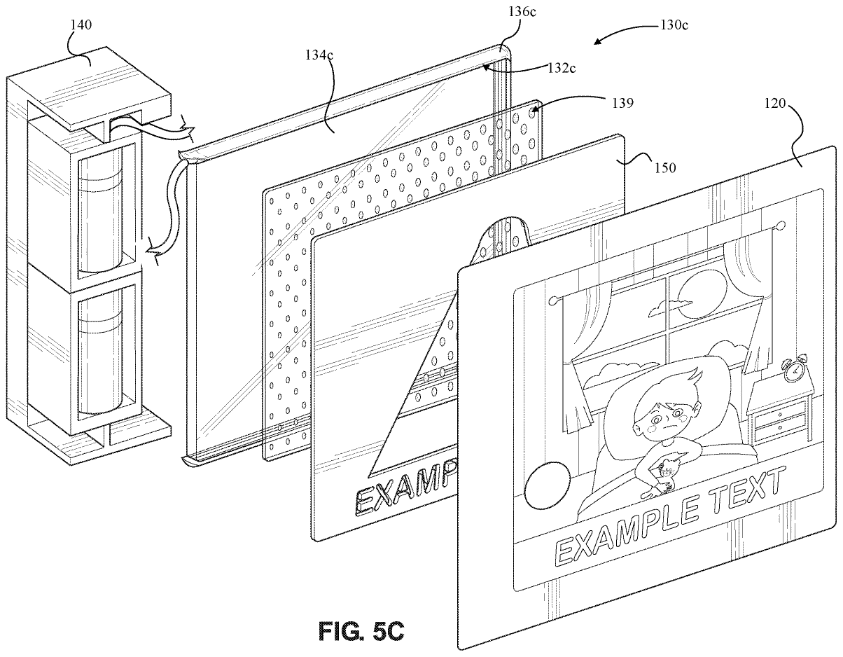

With reference to FIGS. 5A-C, exemplary embodiments of illuminating layers in accordance with certain embodiments of the invention are shown electrically coupled to a power source 140 and in combination with an exemplary modifying layer 150 and outward-facing printed layer 120.

For instance, turning to FIG. 5A, an exemplary illuminating layer 130 may be the aforementioned side-lit LED light guide plate 132 comprising a thin, flexible PVC or acrylic panel 136 (shown here independent of any aforementioned frame), in combination with an additional layer 131 comprising microdots 139 to enable even distribution of light across the panel 136, thereby uniformly illuminating the page 110.

In some embodiments, as shown in FIG. 5B, the illuminating layer 130b may be an electroluminescent light panel (“EL panel”). It is contemplated that using an EL panel in this manner may increase the type and configuration of lighting effects available, as EL panels provide a thin, uniform light source well-suited to the layered page construction described herein. In such cases, it may be possible to forego additional diffusing layers.

In still other embodiments, as shown in FIG. 5C, the illuminating layer 130c may comprise flexible LED ribbon lights 132c arranged and secured along an edge of a flexible panel 134c to effectuate an apparently solid but diffuse backlight for the outward-facing printed layer 120 and any modifying layers 150. As above, a reflective frame or strip 136c may be provided to direct light inward and prevent leakage at the edge of the panel 134c.

It is contemplated that cuttable LED sheets, fairy lights and/or LED light arrays may also be used to practice the invention, in which case additional diffuser layer(s) may be employed to spread the light sufficiently to obscure the individual light sources through the outward-facing printed layer 120.

In view of the foregoing, it will be appreciated that in some embodiments, the illuminating layer 130 may comprise a combination of components configured to achieve visually uniform backlighting of the outward-facing printed layer 120.

It is contemplated that each illuminating layer, such as the exemplary EL panel 130b of FIG. 5B or side-lit LED light guide plate 136 of FIG. 5A may be sized to correspond to the dimensions of the outward-facing printed layer 120. However, the outward-facing printed layer 120 may extend beyond the boundaries of the illuminating layer 130 so as to fully conceal the illuminating layer 130 and any associated wiring, such as wiring 153, or circuitry from view.

In some exemplary embodiments, the illuminating layer 130 may be about 5 cm wide to about 25 cm wide and about 5 cm tall to about 25 cm tall. However, it will be appreciated that none of the book, pages, outward-facing printed layers, front cover, back cover, modifying layers, or illuminating layers need be quadrilateral or rectangular to practice the invention. The particular shape and configuration of the components of the book, including those comprising its layered pages, are provided for simplicity and clarity only and not for limitation.

In some embodiments, the illuminating layer 130 may define a panel of about 10 cm×10 cm configured to run off a conventional 3V power source, permitting use of conventional AA, AAA, or even coin cell batteries. Larger panels may also be used, though one of ordinary skill in the art will appreciate that these may require proportionally more power due to increased energy demands.

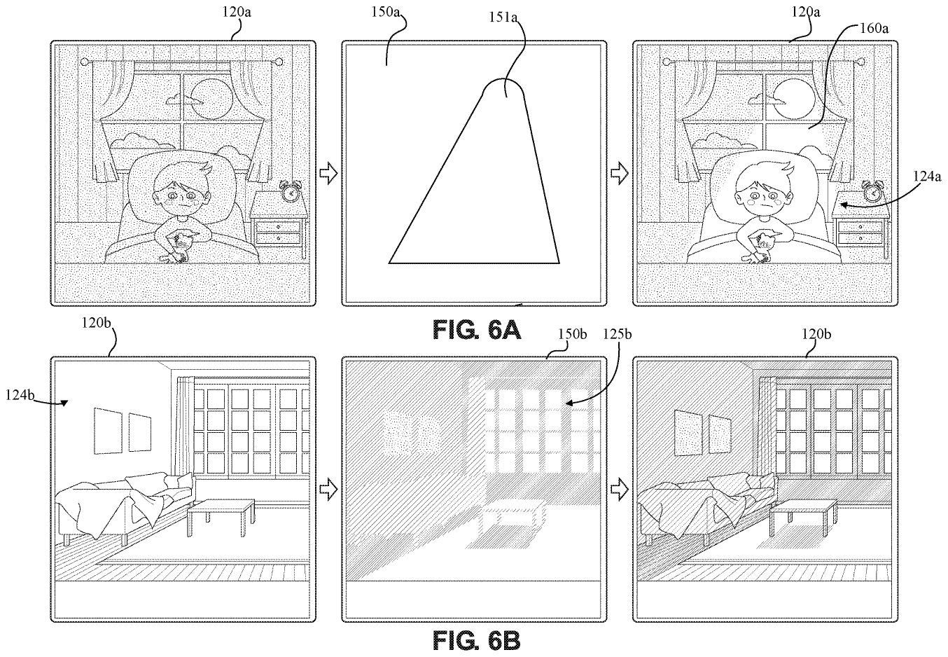

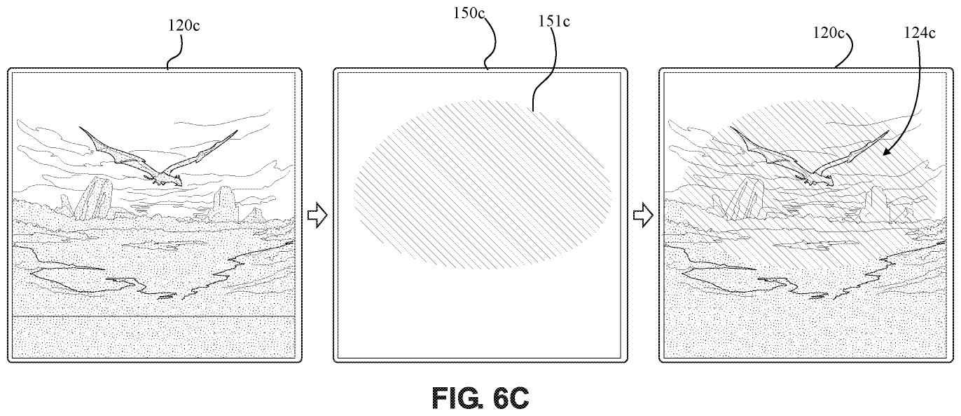

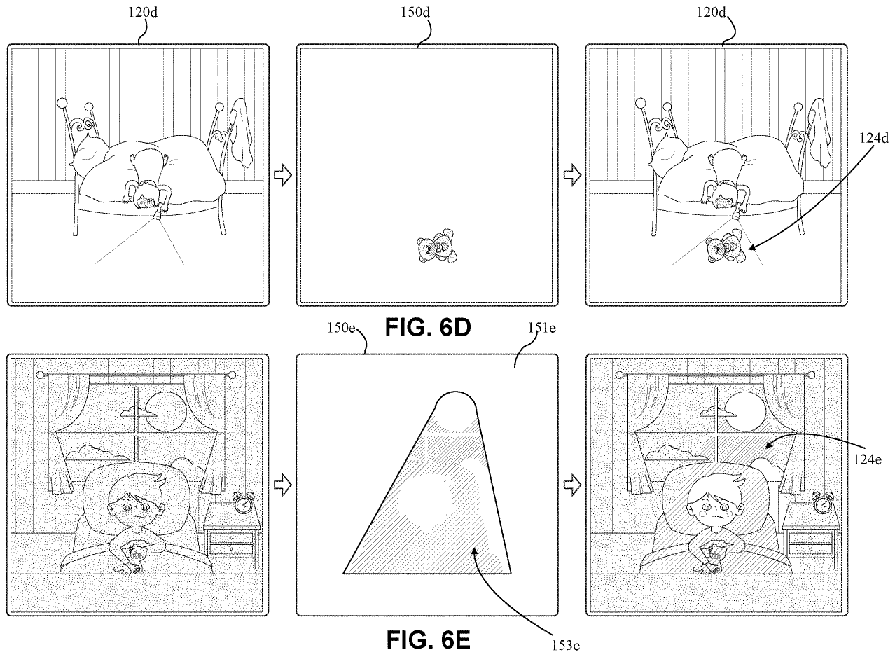

FIGS. 6A-6E illustrate exemplary alternative embodiments of modifying layers 150 in combination with outward-facing printed layers 120. In each of FIGS. 6A-6E, each exemplary and nonlimiting modifying layer is shown together with its corresponding outward-facing printed layer, followed by the resulting visual effect produced when any of the possible illuminating layers (not shown) are activated behind them.

For instance, FIG. 6A illustrates an exemplary cutout “highlight” effect. In such embodiment, the modifying layer 150a may be an opaque sheet, such as that previously discussed. In some exemplary embodiments, the opaque sheet may be black cardstock, or another material capable of preventing the transmission of light through the outward-facing printed layer 120a, cut or otherwise shaped to block penetration of light from the illuminating layer (not shown) in all areas except for designated cutout 151a portions. The resulting illuminated outward-facing printed layer 120a exhibits a highlight effect 160a that draws the reader's attention to a featured portion of the illustrations 124a or text, as the case may be, visible thereon.

It is contemplated that the modifying layer 150a may be configured and arranged to at least permit the passage of light through any text appearing on the outward-facing printed layer 120a, so that text may remain fully readable when the illuminating layer is activated.

FIG. 6B illustrates an exemplary color transformation effect. In such embodiment, the outward-facing printed layer 120b may feature an illustration 124b rendered in black and white or with reduced color. When the illuminating layer (shown elsewhere) is activated, the illustration 124b may appear in color or more deeply saturated. This effect is produced by a modifying layer 150b comprising a light-permeable sheet having a colored image or color printing 125b applied to its surface, interposed between the outward-facing printed layer 120b and the illuminating layer. In this manner, certain pages may present a visually dynamic experience, allowing a reader to toggle illumination to reveal a color transformation.

It is contemplated that each page configured to produce this exemplary effect may be individually configured with a modifying layer tailored to the particular illustration featured thereon.

Turning to FIG. 6C, a light-filtering modifying layer 150c may comprise a colored film 151c or printed surface interposed between the outward-facing printed layer 120c and the illuminating layer and configured to tint or otherwise affect the perceived color, brightness, or contrast of a desired portion of the any text and/or illustrations 124c appearing on the outward-facing printed layer 120c when backlit.

FIG. 6D illustrates an exemplary “hidden image” reveal effect in which the modifying layer 150d comprises an image or feature drawn or printed in high contrast thereon on the may be revealed through an outward-facing printed layer 120d of relatively low visual contrast when the illuminating layer is powered on. In this manner, illustrations 124d that might otherwise be invisible to the reader may be revealed upon activation of the illuminating layer, providing an engaging interactive element for the reader.

FIG. 6E illustrates an exemplary combination effect in which a cutout highlight and color addition are combined within a single page. In such embodiment, the modifying layer 150e may be configured to both block light in certain areas 151e, thereby creating a highlight effect on a featured portion of the illustration 124e, and to add color through a light-permeable colored portion 153e of the modifying layer 150e, thereby achieving multiple visual effects simultaneously upon activation of the illuminating layer.

Of course, the foregoing represent only a few exemplary configurations of modifying layers provided for the sake of example. It will be understood by one of ordinary skill in the art that any number of the foregoing exemplary embodiments can be combined or modified as desired to produce innumerable illumination effects on the outward-facing printed layer without departing from the invention. Many other materials, arrangements, and combinations thereof may be employed to produce a wide variety of visual effects on the outward-facing printed layer when backlit. Indeed, the number, type, and configuration of modifying layers may vary depending on the particular lighting effects desired for each individual page, and pages without any illuminating features may also be included in the book without departing from the invention.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### CONCLUSIONS, RAMIFICATIONS, AND SCOPE

While certain embodiments of the invention have been illustrated and described, various modifications are contemplated and can be made without departing from the spirit and scope of the invention. For example, the particular form, appearance, meaning, and content of any text and/or illustrations provided on the outward-facing printed layer may vary according to the taste and preferences of any intended readers. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the book with individually illuminated, design-integrated pages for reading in low light with which that terminology is associated. In general, the terms used in the following claims should not be constructed to limit the book with individually illuminated, design-integrated pages for reading in low light to the specific embodiments disclosed in the specification unless the above description section explicitly define such terms. Accordingly, the actual scope encompasses not only the disclosed embodiments, but also all equivalent ways of practicing or implementing the disclosed system, method and apparatus. The above description of embodiments of the book with individually illuminated, design-integrated pages for reading in low light is not intended to be exhaustive or limited to the precise form disclosed above or to a particular field of usage.

While specific embodiments of, and examples for, the method, system, and apparatus are described above for illustrative purposes, various equivalent modifications are possible for which those skilled in the relevant art will recognize.

While certain aspects of the method and system disclosed are presented below in particular claim forms, various aspects of the method, system, and apparatus are contemplated in any number of claim forms. Thus, the inventor reserves the right to add additional claims after filing the application to pursue such additional claim forms for other aspects of the book with individually illuminated, design-integrated pages for reading in low light.

What is claimed is:

1. A book, comprising:
a plurality of pages disposed between a front cover and back cover and coupled to one another along a spine, each page comprising an outward-facing printed layer comprising text, illustrations, or a combination of the same, and a selectively illuminating layer positioned behind the outward-facing printed layer and operative to backlight the outward-facing printed layer; and
a power source operatively coupled to each illuminating layer and configured to selectively supply electrical power thereto.

2. The book of claim 1, wherein each page further comprises at least one modifying layer disposed between the outward-facing printed layer and illuminating layer.

3. The book of claim 2, wherein the at least one modifying layer comprises a sheet configured and arranged to selectively block, filter, or transmit light from the illuminating layer so as to produce at least one visual effect on the outward-facing printed layer.

4. The book of claim 3, wherein the at least one visual effect is selected from the group consisting of a highlight, a shadow, a color transformation, a revealed hidden image, and any combination thereof.

5. The book of claim 1, wherein the illuminating layer is an electroluminescent light panel.

6. The book of claim 1, wherein the illuminating layer is a side-lit LED light guide plate comprising a flexible PVC or acrylic panel having microdots arranged in a matrix pattern configured to distribute light evenly across the panel.

7. The book of claim 1, wherein the outward-facing printed layer is formed as a solid sheet of material selected from the group consisting of cardstock, paper stock, and paperboard.

8. The book of claim 7, wherein the outward-facing printed layer defines an opening configured to permit physical access to a switch operative to control the illuminating layer.

9. The book of claim 1, further comprising a switch disposed on at least one of the front cover, back cover, or spine of the book and operatively coupled to the power source, the switch configured to selectively control illumination of one or more of the illuminating layers.

10. A book, comprising:
a plurality of pages disposed between a front cover and back cover and coupled to one another along a spine, each page comprising
an outward-facing printed layer formed as a solid sheet of material selected from the group consisting of cardstock, paper stock, and paperboard,
at least one modifying layer disposed behind the outward-facing printed layer and configured to selectively block, filter, or transmit light so as to produce a visual effect on the outward-facing printed layer, and
an illuminating layer positioned behind the at least one modifying layer and operative to backlight the outward-facing printed layer through the at least one modifying layer; and
a power source housed within at least one of the front cover, back cover, or spine and operatively coupled to each illuminating layer and configured to selectively supply electrical power thereto.

11. The book of claim 10, wherein the outward-facing printed layer defines an opening configured to permit physical access to a switch operative to control the illuminating layer.

12. The book of claim 10, further comprising a switch disposed on at least one of the front cover, back cover, or spine of the book and operatively coupled to the power source, the switch configured to selectively control illumination of one or more of the illuminating layers.

13. The book of claim 10 wherein the illuminating layer is an electroluminescent light panel.

14. The book of claim 10, wherein the illuminating layer is a side-lit LED light guide plate comprising a flexible PVC or acrylic panel having microdots arranged in a matrix pattern configured to distribute light evenly across the panel.

15. The book of claim 10, wherein the at least one visual effect is selected from the group consisting of a highlight, a shadow, a color transformation, a revealed hidden image, and any combination thereof.

16. A page for a book, comprising:
an outward-facing printed layer comprising text, illustrations, or a combination of the same;
at least one modifying layer disposed behind the outward-facing printed layer and configured to selectively block, filter, or transmit light so as to produce a visual effect on the outward-facing printed layer; and
an illuminating layer positioned behind the outward-facing printed layer and operative to backlight the outward-facing printed layer to enable reading in low-light environments;
wherein the page is configured to be bound with a plurality of other pages between a front cover and back cover along a spine, and
wherein the illuminating layer is operatively coupled to a power source configured to selectively supply electrical power thereto.

17. The page of claim 16, wherein the outward-facing printed layer defines an opening configured to permit physical access to a switch operative to control the illuminating layer.

18. The page of claim 16, wherein the illuminating layer is an electroluminescent light panel.

19. The page of claim 16, wherein the illuminating layer is a side-lit LED light guide plate comprising a flexible PVC or acrylic panel having microdots arranged in a matrix pattern configured to distribute light evenly across the panel.

20. The page of claim 10, wherein the at least one visual effect is selected from the group consisting of a highlight, a shadow, a color transformation, a revealed hidden image, and any combination thereof.
